(19) United States
(12) Patent Application Publication
(10) Pub. No.: US 2025/0202857 A1
(43) Pub. Date: Jun. 19, 2025

(54) METHOD AND SYSTEM FOR PROVIDING SCHEDULE NOTIFICATION USING INSTANT MESSAGING APPLICATION

(71) Applicant: LINE Plus Corporation, Seongnam-si (KR)

(72) Inventors: Seok Ju HONG, Seongnam-si (KR); Yujin Kim, Seongnam-si (KR); Heejung Bae, Seongnam-si (KR); Kwang Woo Back, Seongnam-si (KR); Junyeong Yoo, Seongnam-si (KR)

(73) Assignee: LINE Plus Corporation, Seongnam-si (KR)

(21) Appl. No.: 19/070,816

(22) Filed: Mar. 5, 2025

Related U.S. Application Data
(63) Continuation of application No. PCT/KR2023/010123, filed on Jul. 14, 2023.

(30) Foreign Application Priority Data
Sep. 20, 2022 (KR) 10-2022-0118824

(51) Int. Cl. H04L 51/224; H04L 51/04

(52) U.S. Cl. CPC H04L 51/224; H04L 51/04

(57) ABSTRACT

A method for providing a schedule notification using an instant messaging application, the method being performed by one or more processors of a user terminal, includes obtaining a schedule message generated based on schedule information registered in a schedule application, determining a notification date and time based on the schedule message, and displaying the schedule message in a schedule notification area of the user terminal at a position in the instant message application corresponding to the determined notification date and time.

### CROSS-REFERENCE TO RELATED APPLICATION

This application is a continuation of International Application No. PCT/KR2023/010123, filed on Jul. 14, 2023, in the Korean Intellectual Property Receiving Office, which is based on and claims priority to Korean Patent Application No. 10-2022-0118824, filed on Sep. 20, 2022, in the Korean Intellectual Property Office, the disclosures of which are incorporated by reference herein in their entireties.

### BACKGROUND

### 1. Field

The present disclosure relates to a method and a system for providing a schedule notification, and more specifically, to a method and a system for notifying a user of a schedule using an instant messaging application.

### 2. Description of Related Art

With the proliferation of mobile devices such as smartphones and the development of the Internet, the use of instant messaging applications using mobile devices is becoming widespread. Users of the instant messaging applications on their mobile devices may exchange various messages with other users via the chat rooms. In addition, the instant messaging applications are equipped with various functions in addition to message transmitting and receiving, such as search capabilities, games, and video calling features.

Some instant messaging applications are implemented with a schedule notification function. To use this schedule notification function, a user may enter the chat room generated through the instant messaging application, select a schedule registration menu included in the chat room, and register their schedule. In order to utilize the schedule management function provided by a related instant messaging application, the user has to enter a chat room and directly register information related to the schedule, which is inconvenient. Additionally, in order to check the schedule with the schedule management function provided by the related instant messaging application, there are inconveniences of having to enter the chat room, click on the link of the message and perform specific actions for the purpose, etc.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

One or more embodiments provide a method for, a computer program stored in a recording medium for, and an apparatus for providing a schedule notification using an instant messaging application.

Additional aspects will be set forth in part in the description which follows and, in part, will be apparent from the description, or may be learned by practice of the presented embodiments.

According to an aspect of the disclosure, a method for providing a schedule notification using an instant messaging application, the method being performed by one or more processors of a user terminal, may include obtaining a schedule message generated based on schedule information registered in a schedule application, determining a notification date and time based on the schedule message, and displaying the schedule message in a schedule notification area of the user terminal at a position in the instant message application corresponding to the determined notification date and time.

The obtaining the schedule message may include receiving the schedule message from an external device, the schedule message being generated by the external device by converting the schedule information registered in the schedule application into a format associated with the instant messaging application.

The obtaining the schedule message may include obtaining the schedule information registered in the schedule application, and generating the schedule message by converting the obtained schedule information into a format associated with the instant messaging application.

The displaying the schedule message in the schedule notification area may include identifying a schedule type included in the schedule message, and displaying, in the schedule notification area, graphic information associated with the identified schedule type together with at least a portion of the schedule message.

The method may include, after displaying the schedule message in the schedule notification area, receiving a first user input that selects the schedule message displayed in the schedule notification area, based on receiving the first user input, executing an online meeting link included in the schedule message, and based on execution of the online meeting link, executing an online meeting application associated with the schedule message.

The executing the online meeting link included in the schedule message may include determining whether a plurality of meetings are available for participation at a current time, based on at least one stored schedule message, based on determining that the plurality of meetings are available for participation at the current time, displaying a list of meetings available for participation, obtaining a link to a meeting selected by a user from the displayed list of meetings, and executing the obtained link.

The method may include, after displaying the schedule message in the schedule notification area, identifying a schedule end date and end time included in the schedule message, and based on determining that the schedule end date and end time has elapsed, removing the schedule message from the schedule notification area.

The method may include, after displaying the schedule message in the schedule notification area, receiving a second user input that selects the schedule message displayed in the schedule notification area, and based on receiving the second user input, removing the schedule message from the schedule notification area.

The displaying the schedule message in the schedule notification area may include, determining a remaining time until a schedule start date and start time or a schedule end date and end time included in the schedule message, based on determining that the remaining time is within a first range, visualizing the schedule message using a first graphic element, and based on determining that the remaining time is within a second range, visualizing the schedule message using a second graphic element.

The displaying the schedule message in the schedule notification area may include identifying a destination included in the schedule message, determining an estimated time of arrival to the destination based on a mode of transportation and/or a travel speed of a user, a current location of the user, and the destination, and displaying, in the schedule notification area, the determined estimated time of arrival together with at least a portion of the schedule message.

The method may include, after displaying the schedule message in the schedule notification area, determining whether the user has arrived at the destination and based on determining that the user has arrived at the destination, removing the schedule message from the schedule notification area.

The displaying the schedule message in the schedule notification area may include identifying a destination and a participant included in the schedule message, obtaining a current location of a user and a current location of the participant, determining a first estimated time of arrival for the user to arrive at the destination based on a mode of transportation and/or a travel speed of the user, the current location of the user, and the destination, determining a second estimated time of arrival for the participant to arrive at the destination based on a mode of transportation and/or a travel speed of the participant, the current location of the participant, and the destination, and displaying, in the schedule notification area, the first estimated time of arrival and the second estimated time of arrival together with at least a portion of the schedule message.

The displaying the schedule message in the schedule notification area further may include displaying a third graphic element associated with the destination in the schedule notification area, displaying a fourth graphic element associated with the user in the schedule notification area based on the first estimated time of arrival, and displaying a fifth graphic element associated with the participant in the schedule notification area based on the second estimated time of arrival, and the method may include determining a distance between the third graphic element and the fourth graphic element based on the first estimated time of arrival and determining a distance between the third graphic element and the fifth graphic element based on the second estimated time of arrival.

The method may include, after displaying the schedule message in the schedule notification area, determining whether both the user and the participant have arrived at the destination, and based on determining that both the user and the participant have arrived at the destination, removing the schedule message from the schedule notification area.

The method may include obtaining an event message that includes an event area, determining whether a current location of a user is included in the event area, and based on determining that the current location of the user is included in the event area, displaying the event message in the schedule notification area.

The method may include, after displaying the event message in the schedule notification area, determining whether the user has left the event area and based on determining that the user has left the event area, removing the event message from the schedule notification area.

The schedule notification area may be included in at least one of a screen area where a chat list of the instant messaging application is displayed, a home screen area of the instant messaging application, and a screen area where a widget of the user terminal is displayed.

The method may include, based on the schedule message being obtained, displaying a schedule management message associated with a management of the schedule message in a chat list of the instant messaging application, and based on receiving a third user input that selects the schedule management message, outputting a user interface associated with editing the schedule message.

According to an aspect of the disclosure, a non-transitory, computer-readable recording medium may store instructions that, when executed by one or more processors, cause a user terminal to obtain a schedule message generated based on schedule information registered in a schedule application, determine a notification date and time based on the schedule message, and display the schedule message in a schedule notification area of the user terminal at a position in an instant message application corresponding to the determined notification date and time.

According to an aspect of the disclosure, a user terminal may include a display, memory storing instructions, and one or more processors, where the instructions, when executed by the one or more processors, cause the user terminal to obtain a schedule message generated based on schedule information registered in a schedule application, determine a notification date and time based on the schedule message, and display, on the display, the schedule message in a schedule notification area at a position in an instant message application corresponding to the determined notification date and time.

### BRIEF DESCRIPTION OF DRAWINGS

The above and other aspects, features, and advantages of certain example embodiments of the present disclosure will be more apparent from the following description taken in conjunction with the accompanying drawings, in which:

FIG. 1 is a diagram illustrating a screen of a user terminal including a schedule message according to one or more embodiments;

FIG. 2 is a schematic diagram illustrating a configuration in which an information processing system is communicatively connected to a plurality of user terminals according to one or more embodiments;

FIG. 3 is a block diagram of an internal configuration of the user terminal and the information processing system according to one or more embodiments;

FIG. 4 is a block diagram of an internal configuration of a processor of the user terminal according to one or more embodiments;

FIG. 5 is a flowchart illustrating a process of acquiring a schedule message from the user terminal according to one or more embodiments;

FIG. 6 is a diagram illustrating a first user interface provided by a schedule application according to one or more embodiments;

FIG. 7 is a diagram illustrating a screen of the user terminal on which a first schedule message is displayed according to one or more embodiments;

FIG. 8 is a diagram illustrating a screen of the user terminal on which a second schedule message is visualized with graphic elements that vary over time according to one or more embodiments;

FIG. 9 is a diagram illustrating a screen of the user terminal on which a third schedule message is displayed according to one or more embodiments;

FIG. 10 is a diagram illustrating a screen of the user terminal on which a graphic element associated with a fourth schedule message is updated over time according to one or more embodiments;

FIG. 11 is a diagram illustrating a screen of the user terminal on which an event message is displayed according to one or more embodiments;

FIG. 12 is a diagram illustrating a screen of the user terminal on which a schedule message is displayed through a schedule notification area fixed at the top of a chat list according to one or more embodiments;

FIG. 13 illustrates an example of a second user interface associated with editing a schedule message according to one or more embodiments; and

FIG. 14 is a flowchart illustrating a method for notifying a schedule using an instant messaging application according to one or more embodiments.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms.

Advantages and features of the disclosed examples and methods of accomplishing the same will be apparent by referring to examples described below in connection with the accompanying drawings. However, the present disclosure is not limited to the examples disclosed below, and may be implemented in various forms different from each other, and the examples are merely provided to make the present disclosure complete, and to fully disclose the scope of the disclosure to those skilled in the art to which the present disclosure pertains.

The singular forms “a,” “an,” and “the” as used herein may include the plural forms as well, unless the context clearly indicates the singular forms. Further, the plural forms are intended to include the singular forms as well, unless the context clearly indicates the plural forms. Further, throughout the description, when a portion is stated as “comprising (including)” a component, it is intended to mean that the portion may additionally comprise (or include or have) another component, rather than excluding the same, unless specified to the contrary. The steps of all methods described herein may be performed in any suitable order unless otherwise indicated herein or otherwise clearly contradicted by context, and are not limited to the described order.

Further, the term “module” or “unit” as used herein refers to a software or hardware component, and the “module” or the “unit” performs certain roles. However, the meaning of the “module” or “unit” is not limited to software or hardware. The “module” or “unit” may be configured to be in an addressable storage medium or configured to execute one or more processors. Accordingly, as an example, the “module” or “unit” may include components such as software components, object-oriented software components, class components, and task components, and at least one of processes, functions, attributes, procedures, subroutines, program code segments, drivers, firmware, micro-codes, circuits, data, database, data structures, tables, arrays, or variables. Functions provided in the components and the “modules” or “units” may be combined into a smaller number of components and “modules” or “units”, or further divided into additional components and “modules” or “units.”

The “module” or “unit” may be implemented as a processor and a memory. The “processor” should be interpreted broadly to encompass a general-purpose processor, a central processing unit (CPU), a microprocessor, a digital signal processor (DSP), a controller, a microcontroller, a state machine, etc. Under some circumstances, the “processor” may refer to an application-specific integrated circuit (ASIC), a programmable logic device (PLD), a field-programmable gate array (FPGA), etc. The “processor” may refer to a combination of processing devices, e.g., a combination of a DSP and a microprocessor, a combination of a plurality of microprocessors, a combination of one or more microprocessors in conjunction with a DSP core, or any other combination of such configurations. In addition, the “memory” should be interpreted broadly to encompass any electronic component that is capable of storing electronic information. The “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. The memory is said to be in electronic communication with a processor if the processor may read information from and/or to the memory. The memory integrated with the processor is in electronic communication with the processor.

In the present disclosure, a “system” may refer to at least one of a server apparatus and a cloud apparatus, but is not limited thereto. For example, the system may include one or more server apparatus. In another example, the system may include one or more cloud apparatus. In still another example, the system may include both the server apparatus and the cloud apparatus operated in conjunction with each other.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

In addition, in the following examples, if a certain component is stated as being “connected,” “combined” or “coupled” to another component, it is to be understood that there may be yet another intervening component “connected,” “combined” or “coupled” between the two components, although the two components may also be directly connected or coupled to each other.

In addition, as used in the following examples, “comprise” and/or “comprising” does not foreclose the presence or addition of one or more other elements, steps, operations, and/or devices in addition to the recited elements, steps, operations, or devices.

Hereinafter, embodiments of the present disclosure will be described in detail with reference to the accompanying drawings.

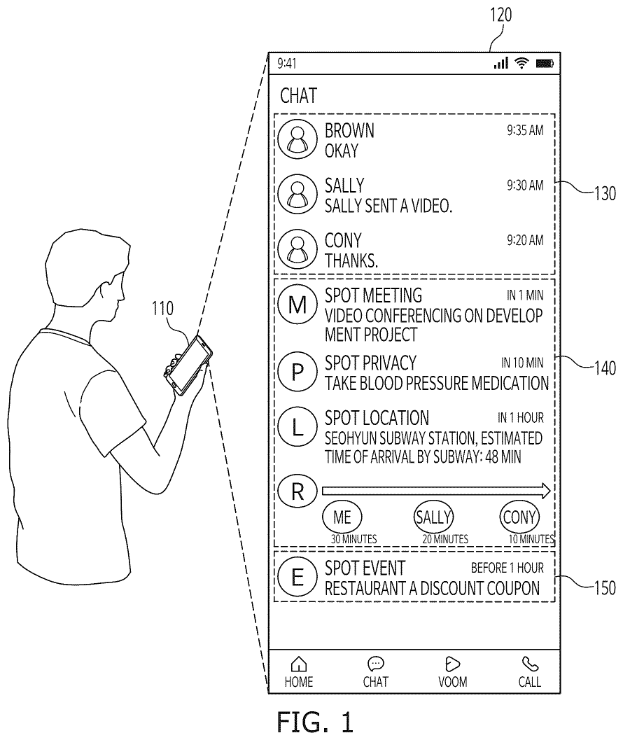

FIG. 1 is a diagram illustrating a screen 120 of a user terminal 110 including a schedule message 140 according to one or more embodiments. The user terminal 110 may display, in a chat list, chat messages 130 exchanged with conversation counterparts through the instant messaging application. FIG. 1 illustrates that the chat list including the chat messages 130 exchanged between the user and each of “Brown”, “Sally”, and “Cony”.

Various types of schedule messages 140 may be displayed on the chat list of the user terminal 110. The schedule messages 140 may be fixedly displayed in a partial area of the entire area where the chat list is displayed. Alternatively, the schedule messages 140 may be sorted in the order of received time and displayed together with the general chat messages 130 within the entire area where the chat list is displayed. Additionally or alternatively, the schedule messages 140 may be displayed in a home screen area of the instant messaging application or in a screen area where a widget of the user terminal 110 is displayed.

FIG. 1 illustrates four types of schedule messages 140 as being displayed, and at least one of these messages may be generated based on schedule information registered in a schedule application. The schedule application may be an application for schedule management installed on the user terminal 110.

A first type of schedule message (schedule message related to Spot Meeting) illustrated in FIG. 1 may be a schedule message related to meeting participation (indicated by M), and a second type of schedule message (schedule message related to Spot Privacy) may be a message for reminding a personal schedule (indicated by P). In addition, a third type of schedule message (schedule message related to Spot Location) illustrated in FIG. 1 may be a schedule message related to an appointment location (indicated by L), and a fourth schedule message (schedule message related to arrow graphics) may be a schedule message related to a meeting attended by a plurality of participants (indicated by R). In addition, as illustrated in FIG. 1, a location-based event message 150 may be displayed in the chat list.

The schedule message may be displayed in a schedule notification area. The schedule notification area may be at least one of the screen area where the chat list of the instant messaging application is displayed, the home screen area of the instant messaging application, or the screen area where the widget of the user terminal is displayed. The event message may also be displayed together with the schedule message in the schedule notification area.

As illustrated in FIG. 1, the schedule messages may be classified into various types. In addition, each schedule message may have different graphic information displayed based on its type. A profile image associated with a corresponding schedule message type may be used as the graphic information. As illustrated in FIG. 1, “M” may be displayed as a profile image associated with the first type of schedule message, and “P” may be displayed as a profile image associated with the second type of schedule message. “L” may be displayed as a profile image associated with the third type of schedule message, and “R” may be displayed as a profile image associated with the fourth type of schedule message. In addition, “E” may be displayed as a profile image associated with the event message.

Additionally or alternatively, the color of the profile image may be determined differently based on the type of each schedule message. For example, the color of the profile image associated with each of the first type of schedule message, the second type of schedule message, the third type of schedule message, and the fourth type of schedule message may be determined to be a first color, a second color, a third color, and a fourth color. The color of the profile image associated with the event message may be determined to be a fifth color.

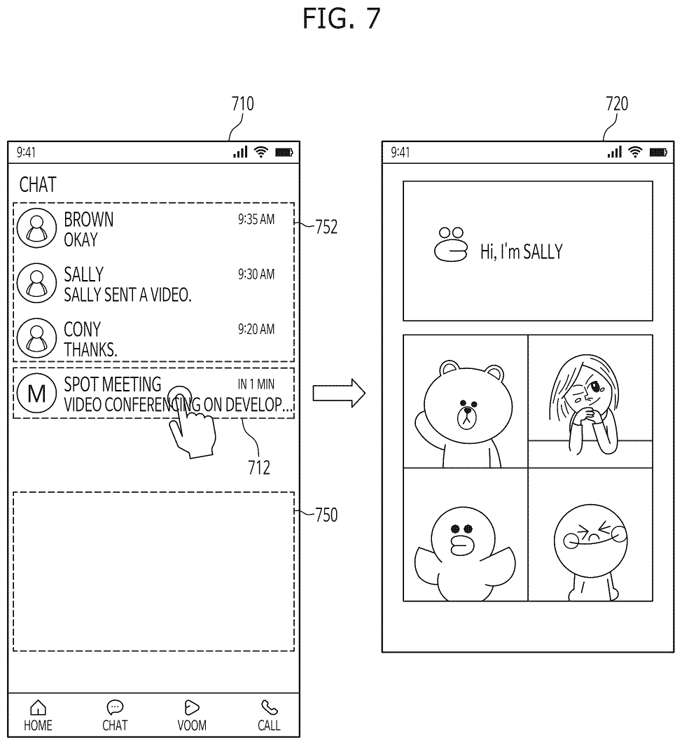

Embodiments of displaying and removing each type of schedule message and event message will be described in more detail with reference to FIGS. 7 to 11.

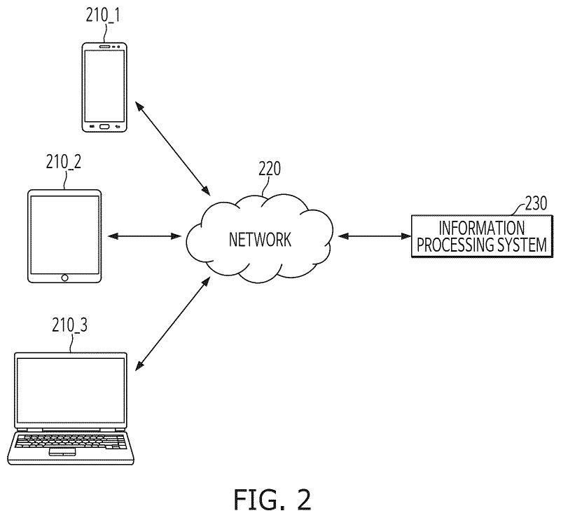

FIG. 2 is a schematic diagram illustrating a configuration in which the information processing system 230 is communicatively connected to a plurality of user terminals 210_1, 210_2, and 210_3 according to one or more embodiments. As illustrated, the plurality of user terminals 2101, 210_2, and 210_3 may be connected to the information processing system 230 that is capable of providing the instant messaging service via a network 220. In this case, the plurality of user terminals 210_1, 210_2, and 2103 may include terminals of the users receiving the instant messaging service.

The information processing system 230 may include one or more server apparatus and/or databases capable of storing, providing, and executing computer-executable programs (e.g., downloadable applications) and data associated with providing the instant messaging service, or one or more distributed computing devices and/or distributed databases based on cloud computing services.

The instant messaging service provided by the information processing system 230 may be provided to the user through the instant messaging application, etc. installed on each of the plurality of user terminals 210_1, 210_2, and 210_3. For example, the information processing system 230 may transmit the instant messages received from the user terminals 210_1, 210_2, and 210_3 to a designated destination (i.e., a terminal of a conversation counterpart) through the instant messaging application, etc.

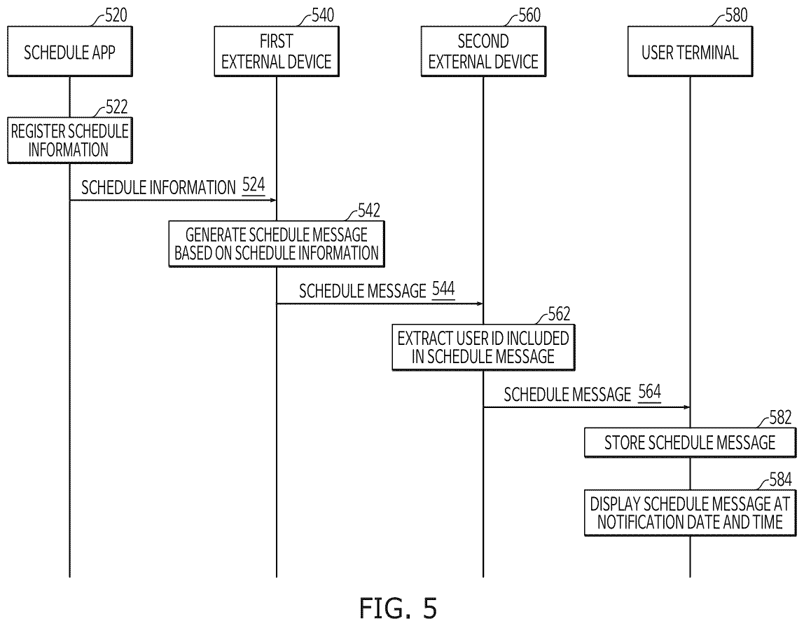

If the schedule information is registered in the schedule application installed on the user terminals 2101, 210_2, and 210_3, the information processing system 230 may receive the schedule information from the user terminals 210_1, 210_2, and 210_3. The information processing system 230 may convert the received schedule information into a format of an instant message (i.e., a format associated with the instant messaging application) to generate a schedule message, and then transmit the schedule message to the user terminals 2101, 210_2, and 210_3. The information processing system 230 may include a plurality of external devices. A method for generating and transmitting a schedule message through a plurality of external devices will be described below with reference to FIG. 5.

The plurality of user terminals 2101, 210_2, and 2103 may communicate with the information processing system 230 through the network 220. The network 220 may be configured to enable communication between the plurality of user terminals 2101, 210_2, and 210_3 and the information processing system 230. The network 220 may be configured as a wired network such as Ethernet, a wired home network (Power Line Communication), a telephone line communication device and RS-serial communication, a wireless network such as a mobile communication network, a wireless local area network (LAN) (WLAN), Wi-Fi, Bluetooth, and ZigBee, or a combination thereof, depending on the installation environment. The method of communication may include a communication method using a communication network (e.g., mobile communication network, wired Internet, wireless Internet, broadcasting network, satellite network, etc.) that may be included in the network 220 as well as short-range wireless communication between the user terminals 210_1, 210_2, and 210_3, but embodiments are not limited thereto.

In FIG. 2, a mobile phone terminal 2101, a tablet terminal 210_2, and a personal computer (PC) terminal 210_3 are illustrated as the examples of the user terminals, but embodiments are not limited thereto, and the user terminals 2101, 210_2, and 210_3 may be any computing device that is capable of wired and/or wireless communication and that may be installed with the instant messaging application, the web browser, etc. and execute the same. For example, the user terminal may include an artificial intelligence (AI) speaker, a smart phone, a mobile phone, a navigation, a computer, a notebook, a digital broadcasting terminal, a personal digital assistant (PDA), a portable multimedia player (PMP), a tablet PC, a game console, a wearable device, an internet of things (IoT) device, a virtual reality (VR) device, an augmented reality (AR) device, a set-top box, etc. In addition, FIG. 2 illustrates that three user terminals 2101, 210_2, and 210_3 are in communication with the information processing system 230 through the network 220, but embodiments are not limited thereto, and a different number of user terminals may be configured to be in communication with the information processing system 230 through the network 220.

Upon receiving the schedule message from the information processing system 230, the user terminals 210_1, 210_2, and 210_3 may determine a notification date and time based on the schedule message and display the schedule message in the schedule notification area at the notification date and time. Displaying the schedule message in the schedule notification area may refer to displaying at least one of a title, part of the text, or all of the text included in the schedule message in the schedule notification area. The text may include at least one of an appointment location, participants, notes, or an attached file. Displaying the schedule message in the scheduled notification area at the determined notification date and time may refer to displaying the schedule message in the instant messaging application or in the schedule notification area at a position among displayed messages that corresponds to the notification date and time. For example, the schedule message may be displayed at a position that corresponds to the notification date and time of the schedule message in relation to other messages within a timing sequence of messages. That is, if the schedule notification area includes multiple notifications of different dates and times, the schedule message may be displayed at a position among the multiple notifications that corresponds to the date and time of the schedule message with respect to the other notification messages. For example, if the schedule notification area includes a first message corresponding to a first date and time, and a second message corresponding to a second date and time, and the schedule message is determined to have a date and time that is between the dates and times of the first message and the second message, then the schedule message may be displayed at a position that is between the first message and the second message on the display of the user terminal.

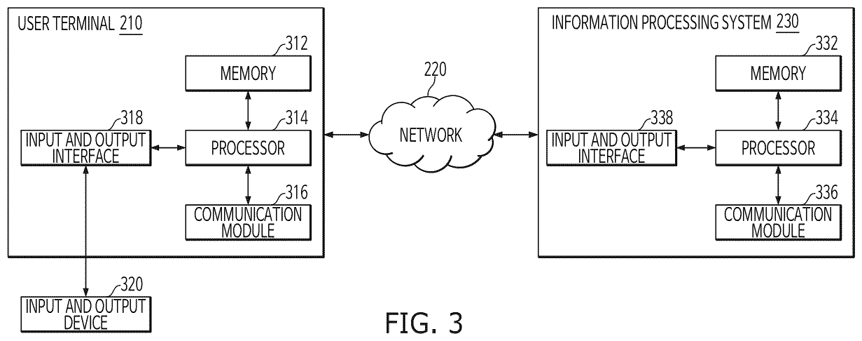

FIG. 3 is a block diagram of an internal configuration of the user terminal 210 and the information processing system 230 according to one or more embodiments. The user terminal 210 may refer to any computing device that is capable of executing the instant messaging application, etc. and that is also capable of wired/wireless communication, and may include the mobile phone terminal 210_1, the tablet terminal 210_2, and the PC terminal 210_3 of FIG. 2, for example. As illustrated, the user terminal 210 may include a memory 312, a processor 314, a communication module 316, and an input/output interface 318. Likewise, the information processing system 230 may include a memory 332, a processor 334, a communication module 336, and an input/output interface 338. As illustrated in FIG. 3, the user terminal 210 and the information processing system 230 may be configured to communicate information, data, etc. through the network 220 using the respective communication modules 316 and 336. In addition, an input/output device 320 may be configured to input information, data, etc. to the user terminal 210, or output information, data, etc. generated from the user terminal 210 through the input/output interface 318.

The memories 312 and 332 may include any non-transitory computer-readable recording medium. The memories 312 and 332 may include a permanent mass storage device such as ROM, disk drive, solid state drive (SSD), flash memory, etc. As another example, a non-volatile mass storage device such as ROM, SSD, flash memory, disk drive, etc. may be included in the user terminal 210 or the information processing system 230 as a separate permanent storage device that is distinct from the memory. In addition, an operating system and at least one program code (e.g., a code for the instant messaging application, etc. installed and driven in the user terminal 210) may be stored in the memories 312 and 332.

These software components may be loaded from a computer-readable recording medium separate from the memories 312 and 332. Such a separate computer-readable recording medium may include a recording medium directly connectable to the user terminal 210 and the information processing system 230, and may include a computer-readable recording medium such as a floppy drive, a disk, a tape, a digital video disc/compact disc ROM (DVD/CD-ROM) drive, a memory card, etc., for example. In another example, the software components may be loaded into the memories 312 and 332 through the communication modules rather than the computer-readable recording medium. For example, at least one program may be loaded into the memories 312 and 332 based on a computer program installed by files provided by developers or a file distribution system that distributes an installation file of an application through the network 220.

The processors 314 and 334 may be configured to process the instructions of the computer program by performing basic arithmetic, logic, and input/output operations. The instructions may be provided to the processors 314 and 334 from the memories 312 and 332 or the communication modules 316 and 336. For example, the processors 314 and 334 may be configured to execute the received instructions according to a program code stored in a recording device such as the memories 312 and 332.

The communication modules 316 and 336 may provide a configuration or function for the user terminal 210 and the information processing system 230 to communicate with each other through the network 220, and may provide a configuration or function for the user terminal 210, the information processing system 230, etc. to communicate with another user terminal or another system (e.g., a separate cloud system, etc.). For example, a request or data (e.g., a chat message, etc.) generated by the processor 314 of the user terminal 210 according to a program code stored in a recording device such as the memory 312 may be transmitted to the information processing system 230 through the network 220 under the control of the communication module 316. Conversely, a control signal or command provided under the control of the processor 334 of the information processing system 230 may be sent through the communication module 336 and the network 220 and received by the user terminal 210 through the communication module 316 of the user terminal 210. For example, the user terminal 210 may receive a chat message, a schedule message, etc. from the information processing system 230.

The input/output interface 318 may be a device for interfacing with the input/output device 320. As an example, the input device may include a device such as a camera including an audio sensor and/or an image sensor, a keyboard, a microphone, a mouse, etc., and the output device may include a device such as a display, a speaker, a haptic feedback device, etc. As another example, the input/output interface 318 may be a device for interfacing with a device such as a touch screen, etc. that incorporates a configuration or function for performing inputting and outputting. For example, when the processor 314 of the user terminal 210 processes the instructions of the computer program loaded into the memory 312, a service screen, etc., which is configured with the information, data, etc. provided by the information processing system 230 or another user terminals, may be displayed on the display through the input/output interface 318. While FIG. 3 illustrates that the input/output device 320 is not included in the user terminal 210, embodiments are not limited thereto, and an input/output device may be configured as one device with the user terminal 210. In addition, the input/output interface 338 of the information processing system 230 may be a device for interfacing with a device for inputting or outputting, which may be connected to or included in the information processing system 230. While FIG. 3 illustrates the input/output interfaces 318 and 338 as the components configured separately from the processors 314 and 334, embodiments are not limited thereto, and the input/output interfaces 318 and 338 may be configured to be included in the processors 314 and 334.

The user terminal 210 and the information processing system 230 may include more components than those illustrated in FIG. 3. The user terminal 210 may be implemented to include at least a part of the input/output device 320 described above. In addition, the user terminal 210 may further include another component such as a transceiver, a global positioning system (GPS) module, a camera, various sensors, a database, etc. For example, if the user terminal 210 is a smartphone, it may include components generally included in the smartphone. For example, the user terminal 210 may be implemented such that various components such as an acceleration sensor, a gyro sensor, an image sensor, a proximity sensor, a touch sensor, an illuminance sensor, a camera module, various physical buttons, buttons using a touch panel, input/output ports, a vibrator for vibration, and so on may be further included therein.

While the program for the instant messaging application, etc. is operating, the processor 314 may receive text, image, video, voice and/or operation, etc. input or selected through an input device such as a touch screen connected to the input/output interface 318, a keyboard, a camera including audio sensor and/or image sensor, a microphone, etc., and may store the received text, image, video, voice, and/or operation, etc. in the memory 312 or provide the same to the information processing system 230 through the communication module 316 and the network 220.

The processor 314 of the user terminal 210 may be configured to manage, process and/or store the information, data, etc. received from the input/output device 320, another user terminal, the information processing system 230, a plurality of external systems, etc. The information, data, etc. processed by the processor 314 may be provided to the information processing system 230 through the communication module 316 and the network 220. The processor 314 of the user terminal 210 may send the information, data, etc. to the input/output device 320 through the input/output interface 318 to output the same. For example, the processor 314 may display the received information, data, etc. on a screen of the user terminal 210.

The processor 334 of the information processing system 230 may be configured to manage, process, and/or store information, data, etc. received from a plurality of user terminals 210, a plurality of external systems, etc. The information, data, etc. processed by the processor 334 may be provided to the user terminals 210 through the communication module 336 and the network 220.

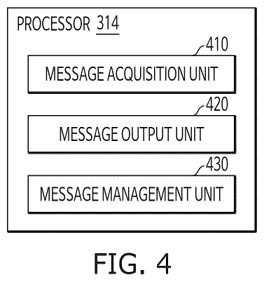

FIG. 4 is a block diagram of an internal configuration of the processor 314 of the user terminal according to one or more embodiments. As illustrated, the processor 314 may include a message acquisition unit 410, a message output unit 420, and a message management unit 430.

The message acquisition unit 410 may receive at least one of a chat message, a schedule message, and an event message from the information processing system and store the received message in a storage device. Additionally or alternatively, the message acquisition unit 410 may generate a schedule message in conjunction with a schedule application installed on the user terminal. For example, the message acquisition unit 410 may generate and store the schedule message based on schedule information registered in the schedule application installed on the user terminal. In this case, the message acquisition unit 410 may convert the schedule information into an instant message format to generate a schedule message having an instant message format. In addition, the message acquisition unit 410 may determine the type of schedule message based on detailed data included in the schedule information and generate a schedule message including the determined type of identification information (e.g., type ID).

If the schedule information includes online meeting link information, the message acquisition unit 410 may determine the schedule message to be the first type. In addition, if the schedule information includes the schedule date and time, but does not include the online meeting information or a destination, the message acquisition unit 410 may determine the schedule message to be the second type. If the schedule information includes destination information, but does not include participant information, the message acquisition unit 410 may determine the schedule message to be the third type. If the schedule information includes the destination information and the participant information, the message acquisition unit 410 may determine the schedule message to be the fourth type.

The message output unit 420 may determine the notification date and time based on the schedule message and display the schedule message in the schedule notification area at the determined notification date and time. The schedule message may include a schedule start date and time, and the message output unit 420 may determine the schedule start date and time or n minutes before the schedule start date and time to be the notification date and time. The message output unit 420 may determine the notification date and time based on the type of each schedule message. For example, for the first type of schedule message, the message output unit 420 may determine a first time period before the schedule start date and time to be the notification date and time, and for the second type of schedule message, the message output unit 420 may determine a second time period before the start date and time to be the notification date and time. As another example, for the third type of schedule message, the message output unit 420 may determine a third time period before the start date and time to be the notification date and time, and for the fourth type of schedule message, the message output unit 420 may determine a fourth time before the start date and time to be the notification date and time.

The notification date and time may be included in the schedule information registered in the schedule application. That is, when registering the schedule through the schedule application, the user may register not only the schedule start date and time but also the notification date and time. In this case, the schedule message may include the schedule start date and time and the notification date and time, and the message output unit 420 may display the schedule message in the schedule notification area at the notification date and time included in the schedule message.

The message management unit 430 may manage a display state of the schedule message displayed in the schedule notification area. The message management unit 430 may determine a removal time of schedule message, and remove the schedule message from the schedule notification area at the determined removal time. The message management unit 430 may remove the schedule message from the schedule notification area at the schedule end date and time included in the schedule message. Additionally or alternatively, the message management unit 430 may remove the schedule message from the schedule notification area if a predetermined time elapses after the schedule start date and time included in the schedule message. Additionally or alternatively, if a user input (e.g., touch or click) for selecting the schedule message is received, the message management unit 430 may remove the schedule message from the schedule notification area.

If the destination is included in the schedule message, the message management unit 430 may remove the schedule message from the schedule notification area in response to determining that the user has arrived at the destination. In this case, until the schedule message is removed from the schedule notification area, the message management unit 430 may determine user's estimated time of arrival periodically or in real time based on at least one of user's travel speed, mode of transportation, distance from the location of the user to the destination, and a current location of the user or the destination and display the determined estimated time of arrival in the schedule notification area with at least a part of the schedule message.

If the destination and the participant are included in the schedule message, the message management unit 430 may determine a first estimated time of arrival for the user to arrive at the destination based on at least one of the travel speed of the user, the mode of transportation, the distance from the user's location to the destination, and the current location of the user or the destination. Additionally, the message management unit 430 may determine a second estimated time of arrival for the participant to arrive at the destination based on at least one of the participant's mode of transportation, the participant's travel speed, a distance from the participant's location to the destination, and a current location or destination of the participant. The message management unit 430 may display the determined first and second estimated times of arrival on the schedule notification area together with at least a part of the schedule message. In response to determining that both the user and the participant have arrived at the destination, the message management unit 430 may remove the schedule message from the schedule notification area. Alternatively, the message management unit 430 may remove the schedule message from the schedule notification area if a predetermined time elapses from the schedule start time, or at the schedule end time.

The message management unit 430 may provide a user interface that allows editing of each schedule message. For example, if the schedule message is acquired, the message management unit 430 may display a schedule management message associated with the management of the schedule message in the chat list of the instant messaging application. If a user input that selects the schedule management message is received, the message management unit 430 may output the user interface associated with editing the schedule message. If the schedule message is edited through the user interface, the message management unit 430 may update the schedule message based on the edited content. The schedule message to be edited may include at least one of a schedule message displayed in the schedule notification area or a schedule message stored without being displayed in the schedule notification area.

FIG. 5 is a flowchart illustrating a process of acquiring a schedule message 564 from a user terminal 580 according to one or more embodiments. FIG. 5 illustrates an example method for generating a schedule message through a first external device 540 and a second external device 560 included in the information processing system and transmitting the generated schedule message to the user terminal 580. The first external device 540 may be a device for interworking with a schedule application 520, and the second external device 560 may be a device for supporting the instant messaging service. Each of the external devices 540 and 560 may be implemented in the form of a server or may be mounted in a cloud computing system in the form of a virtual machine.

The schedule information may be registered in operation 522 in the schedule application 520. For example, the user may register the schedule information, including the schedule start date and time, using the schedule application 520 installed on the user terminal 580. Alternatively, the user may register the schedule information, including the schedule start date and time, using a schedule service provided in a web form. In addition, the schedule information may additionally include at least one of schedule end date and time, title, notes, video conference-related information, meeting place, gathering place, participant identification information, or creator identification information.

The participant identification information or the creator identification information may be a mobile phone number or a login ID. The login ID may be a login ID associated with the instant messaging service or a login ID associated with the schedule service. If the login ID associated with the instant messaging service and the login ID associated with the schedule service are different from each other, ID matching information may be stored in the first external device 540.

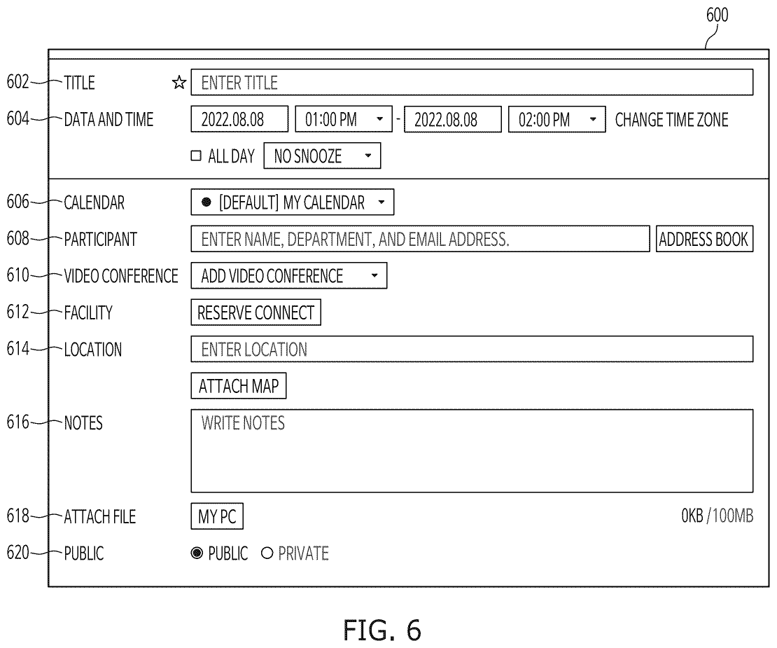

The schedule application 520 may be an application installed on the user terminal 580 or may be an application installed on another user terminal. A first user interface provided through the schedule application 520 will be described below with reference to FIG. 6. Schedule information 524 registered in the schedule application 520 may be transmitted to the first external device 540.

The first external device 540 may generate, in operation 542, a schedule message based on the received schedule information. In this case, the first external device 540 may convert the schedule information 524 into an instant message format (i.e., a format associated with the instant messaging application) to generate a schedule message 544.

The first external device 540 may determine the type of the schedule message based on the detailed data included in the schedule information, and include the determined type of identification information (e.g., type ID) in the schedule message. Different instant message formats may be used according to the types of the schedule message. For example, the first external device 540 may determine the schedule message to be the first type (e.g., Spot Meeting) if the schedule information includes online meeting link information, and determine the schedule message to be the second type (e.g., Spot Privacy) if the schedule information includes the schedule start date and time, but does not include the online meeting information and the destination. As another example, the first external device 540 may determine the schedule message to be the third type (Spot Location) if the schedule information includes destination information, but does not include participant information, and may determine the schedule message to be the fourth type (Spot Realtime) if the schedule information includes the destination information and the participant information.

Tables 1 to 4 below illustrate examples of various types of schedule messages.

TABLE 1

. . .
message type = “Spot Meeting”
title = “avatar meeting”
link = “https://avatar_meeting.line/url1”
start date and time = “2022-07-17 12:00:00”
end date and time = “2022-07-17 12:30:00”
. . .

TABLE 2

. . .
message type = “Spot Privacy”
title = “to take blood pressure medicine”
start date and time = “2022-07-17 12:00:00”
end date and time = “2022-07-17 12:10:00”
. . .

TABLE 3

. . .
message type = “Spot Location”
title = “dinner appointment”
location: “Seohyeon subway station”
mode of transportation: “public transportation”
start date and time = “2022-07-17 18:00:00”
end date and time = “2022-07-17 22:00:00”
. . .

TABLE 4

. . .
message type = “Spot Realtime”
title = “class reunion”
participant = “Sally, Cony”
mode of transportation = “Me: public transportation,
Sally: public transportation, cony: walking”
start date and time = “2022-07-18 17:00:00”
end date and time = “2022-07-18 22:00:00”
. . .

Referring to Tables 1 to 4, the schedule message illustrated in Table 1 is a message associated with the first type (Spot Meeting) and may include an online meeting link address. In addition, the schedule message illustrated in Table 2 is a message related to the second type (Spot Privacy) and may include information to remind the user of personal life patterns or schedules (e.g., taking medication). The schedule message illustrated in Table 3 is a message related to the third type (spot location) and may include the destination and the mode of transportation. The schedule message illustrated in Table 4 is a message related to the fourth type (Spot Realtime) and may include the destination, the participant information, and the mode of transportation for each participant.

After the schedule message having a specific type is generated, the first external device 540 may transmit the generated schedule message 544 to the second external device 560. In this case, the schedule message 544 may include the user identification information. The user identification information is identification information of a user who registered the schedule information in the schedule application, and may be a mobile phone number or a login ID associated with the instant messaging application.

The second external device 560 may extract, in operation 562, the user identification information included in the schedule message. If the type of the schedule message is the fourth type (Spot Realtime), the second external device 560 may additionally extract the identification information of the participant from the schedule message. The identification information of the participant may be a mobile phone number or a login ID associated with the instant messaging application.

The second external device 560 may transmit the schedule message 564 to the user terminal 580 associated with the user identification information. If the participant identification information is included in the schedule message 564, the second external device 560 may additionally transmit the schedule message to another user terminal associated with the participant identification information.

The user terminal 580 receiving the schedule message may store, in operation 582, the schedule message. The schedule message may be received and stored through the instant messaging application installed on the user terminal 580. In this case, the instant messaging application installed on the user terminal 580 may not immediately display the received schedule message, but keep the received schedule message in an undisplayed state until the notification date and time.

The instant messaging application installed on the user terminal 580 may determine the notification date and time based on the schedule start date and time included in the schedule message and display, in operation 584, the schedule message in the schedule notification area at the notification date and time (e.g., at a position among various messages that corresponds to the notification date and time).

If the schedule information is registered in the schedule application, the schedule information may be converted into a schedule message in the instant message format through the first external device 540, and the schedule message may be transmitted to the user terminal 580 through the second external device 560. The first external device 540 and the second external device 560 may be integrated into a single device.

According to one or more embodiments, the user terminal 580 may also generate the schedule message by itself. For example, the processor of the user terminal 580 may acquire the schedule information registered in the schedule application and convert the acquired schedule information into a format associated with the instant messaging application to generate and store a schedule message.

FIG. 6 is a diagram illustrating a first user interface 600 provided by the schedule application according to one or more embodiments. The first user interface 600 associated with FIG. 6 may be output when a specific date, etc. is selected in the schedule application.

As illustrated in FIG. 6, the first user interface 600 may include a first input field 602 for inputting a title, a second input field 604 for setting a start date and time, an end date and time, and schedule recurrence information of the schedule, and a third input field 606 for determining a calendar to store the schedule. In addition, the first user interface 600 may include a fourth input field 608 for inputting participants in conjunction with an address book, a fifth input field 610 for inputting a link address for an online meeting, a sixth input field 612 for reserving equipment necessary for the online meeting, a seventh input field 614 for inputting a place (e.g., a destination or meeting place), an eighth input field 616 for inputting notes, an ninth input field 618 for attaching a file, and a tenth input field 620 for determining whether to disclose the schedule information.

A eleventh input field for determining a mode of transportation for at least one of the user and the participant may be additionally included in the first user interface 600. The eleventh input field may include a selection list for selecting any one of public transportation, walking, private vehicles, etc. Alternatively, the mode of transportation of the user or the participant may be selected by each user through the instant messaging application installed on their user terminal.

Information on the schedule start or end date and time included in the second input field 604 of the input fields included in the first user interface 600 may be essential information necessary to generate the schedule information. The data input from the input field other than the second input field 604 may be additional information in the schedule information.

The data input through each input field in the first user interface 600 may be included in the schedule information. The type of the schedule message may be determined based on the detailed data included in the schedule information.

FIGS. 7 to 12 illustrate that the schedule notification area is included in the screen area where the chat list of the instant messaging application is displayed, but embodiments are not limited thereto.

FIG. 7 is a diagram illustrating a screen 710 of the user terminal on which a first schedule message 712 is displayed according to one or more embodiments. The first schedule message 712 may be a message corresponding to the first type (Spot Meeting). For example, the schedule notification area may be included in the home screen area of the instant messaging application, in the screen area where the widget of the user terminal is displayed, or in the screen showing a chatroom list (e.g., a chatroom with Brown, a chatroom with Sally, and a chatroom with Cony).

As illustrated in FIG. 7, the first schedule message 712 may be displayed in the schedule notification area at the notification date and time. The schedule notification area may correspond to area 750, area 752 or the entire display area of the instant messaging application. For example, in embodiments where the schedule notification area corresponds to area 750, this area may be exclusively reserved for schedule messages such as message 712. The schedule messages may be arranged in sequential order based on the notification date and time, and more recent messages (i.e., events closer to the current time and date) may be arranged at the top of area 750 and less recent messages may be arranged toward the bottom of area 750. In embodiments where the schedule notification area corresponds to area 752, the schedule notification area 752 may include schedule messages such as message 712, as well as chat messages. In such embodiments, the schedule message 712 may be provided at a position corresponding to a notification date and time with respect to other messages within the notification area 752, even if those other messages are not schedule messages 712. As message 712 has a notification date and time that is closer to a current date and time, the message 712 is displayed below the chat messages above based on this recency. If a chat message has a notification date and time that is closer to the current date and time than the message 712, then this chat message may be displayed at a position closer to the bottom of the area 752 than the message 712.

While the first schedule message 712 is displayed, a first user input that selects the first schedule message 712 may be received. In this case, the online meeting link included in the first schedule message 712 may be immediately executed.

If the first user input is received, at least one processor included in the user terminal may determine whether there are a plurality of meetings available for participation at the current time based on at least one pre-stored schedule message. For example, it may be determined whether there are a plurality of the first type of schedule messages including the current time point as a meeting time stored. In response to determining that there are a plurality of meetings available for participation at the current time point, the processor may display a list of meetings available for participation. In this case, if the user selects any one meeting from the displayed meeting list, the processor may acquire a link for the selected meeting and automatically execute the acquired link.

In response to executing the online meeting link, an online meeting application associated with the schedule message may be executed, and an online meeting screen 720 provided by the online meeting application may be output to the user terminal. FIG. 7 illustrates that the online meeting application associated with the avatar meeting is executed and the online meeting screen 720 including an avatar image instead of a human image is output.

According to one or more embodiments, if the online meeting screen 720 is output, the first schedule message 712 may be removed from the schedule notification area. Removing the first schedule message 712 from the schedule notification area may indicate that the first schedule message 712 disappears from the schedule notification area. In this case, the first schedule message 712 may still be in a stored state in the storage medium.

According to this configuration, if the user selects the first schedule message 712, the online meeting application associated with the link included in the first schedule message 712 is automatically executed such that the hassle of the user having to execute the application separately or enter the chat room to participate in the online meeting may be eliminated.

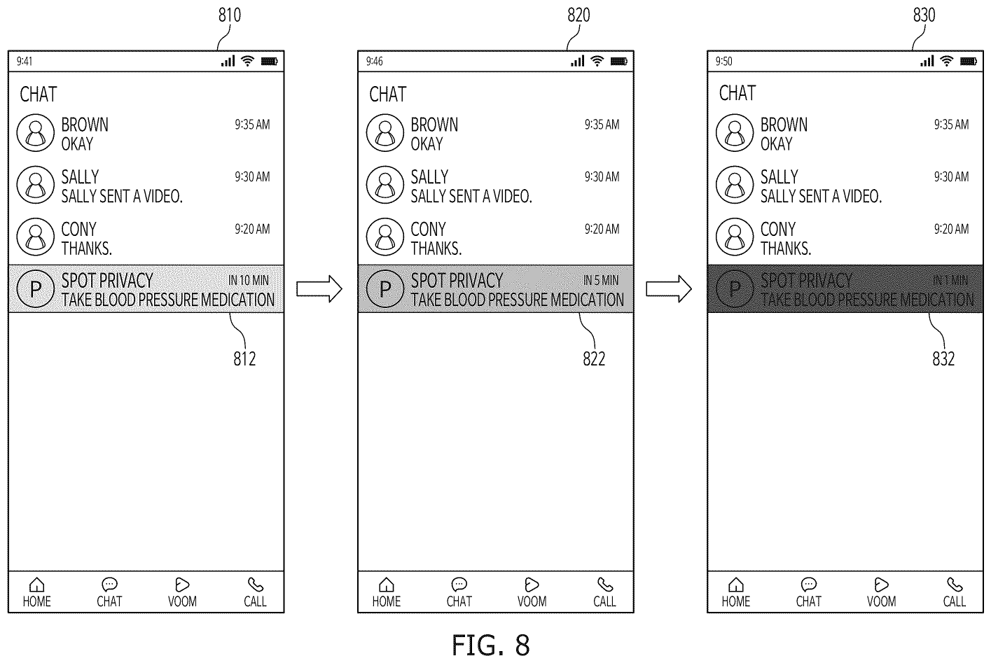

FIG. 8 is a diagram illustrating screens 810, 820, and 830 of the user terminal on which second schedule messages 812, 822, and 832 are visualized with graphic elements that vary over time according to one or more embodiments. The second schedule messages 812, 822, and 832 may be messages corresponding to the second type (Spot Privacy).

As illustrated on the first screen 810 of FIG. 8, 10 minutes before the schedule start time, the second schedule message 812 may be displayed in the schedule notification area. At this time, the second schedule message 812 may be visualized using a first graphic element and displayed in the schedule notification area, and over time, the second schedule messages 822 and 832 visualized using other graphic elements may be displayed in the schedule notification area. The at least one processor included in the user terminal may determine a remaining time until the schedule start date and time or the schedule end date and time included in the second schedule messages 812, 822, and 832, and visualize the second schedule messages 812, 822, and 832 using a specific graphic element based on the determined remaining time.

In FIG. 8, if the remaining time is in a first range (e.g., within 5 to 10 minutes), the second schedule message 812 may be visualized using a first graphic element (e.g., the first color) and displayed in the schedule notification area. If the remaining time is in a second range (e.g., within 1 to 5 minutes), the second schedule message 822 may be visualized using a second graphic element (e.g., the second color). In addition, if the remaining time is in a third range (e.g., within a minute), the second schedule message 832 may be visualized using a third graphic element (e.g., a third color). FIG. 8 illustrates the second schedule message on the screens 810, 820, and 830, which is visualized using graphic elements that vary over time.

In addition to the color, various graphic elements such as visual patterns, icons, animations, etc. may be used to visualize the second schedule message over time. In addition, various types of schedule messages other than the second schedule message may be visualized through the same/similar method.

In response to receiving a second user input that selects the second schedule message, the second schedule message may be determined to be completed and removed from the schedule notification area.

According to one or more embodiments, based on the time remaining until the schedule start or end date and time, at least a part of the schedule message may be displayed together with various graphic elements, allowing the user to intuitively check the remaining time.

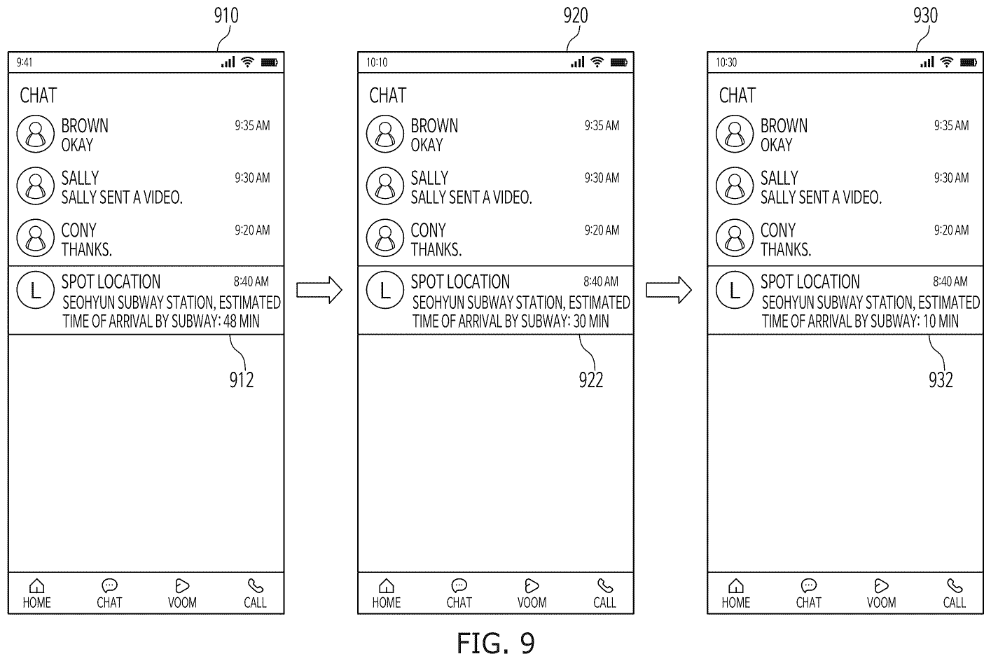

FIG. 9 is a diagram illustrating screens 910, 920, and 930 of the user terminal on which third schedule messages 912, 922, and 932 are displayed according to one or more embodiments. The third schedule messages 912, 922, and 932 may be messages corresponding to the third type (Spot Location), and the estimated time of arrival may be updated and displayed as time elapses. As time elapses after the third schedule message 912 is displayed in the schedule notification area at the notification date and time as illustrated on the first screen 910 of FIG. 9, the estimated times of arrival associated with the third schedule message 922 and 932 may be updated and displayed as illustrated on the second screen 920 and the third screen 930 of FIG. 9.

The processor included in the user terminal may identify the destination included in the third schedule message and display the identified destination in the schedule notification area together with at least a part of the third schedule message. In addition, at least one processor included in the user terminal may extract the user's mode of transportation included in the third schedule message and estimate the user's location. The processor may estimate the user's location based on a Global Navigation Satellite System (GNSS) signal collected using a GPS module included in the user terminal. In this case, the processor may acquire the estimated time of arrival based on the mode of transportation, the current location, and the destination by using a map/path finding application/service.

Alternatively, the processor may determine the travel speed of the user based on a distance traveled by the user during a predetermined time. In addition, the processor may determine the estimated time of arrival to the destination based on the travel speed of the user and the current location and the destination of the user.

The estimated time of arrival acquired by the processor may be displayed in the schedule notification area together with at least a part of the third schedule message. FIG. 9 illustrates that the destination included in the third schedule message is extracted, and the estimated time of arrival is displayed together with the destination in the schedule notification area. The estimated time of arrival may be recalculated in real time or at regular cycle intervals, and the currently displayed estimated time of arrival may be updated to the recalculated estimated time of arrival. As illustrated in FIG. 9, the estimated times of arrival become progressively shorter in the order illustrated in 912, 922, and 932.

If the user has arrived at the destination, the third schedule message may be removed from the schedule notification area.

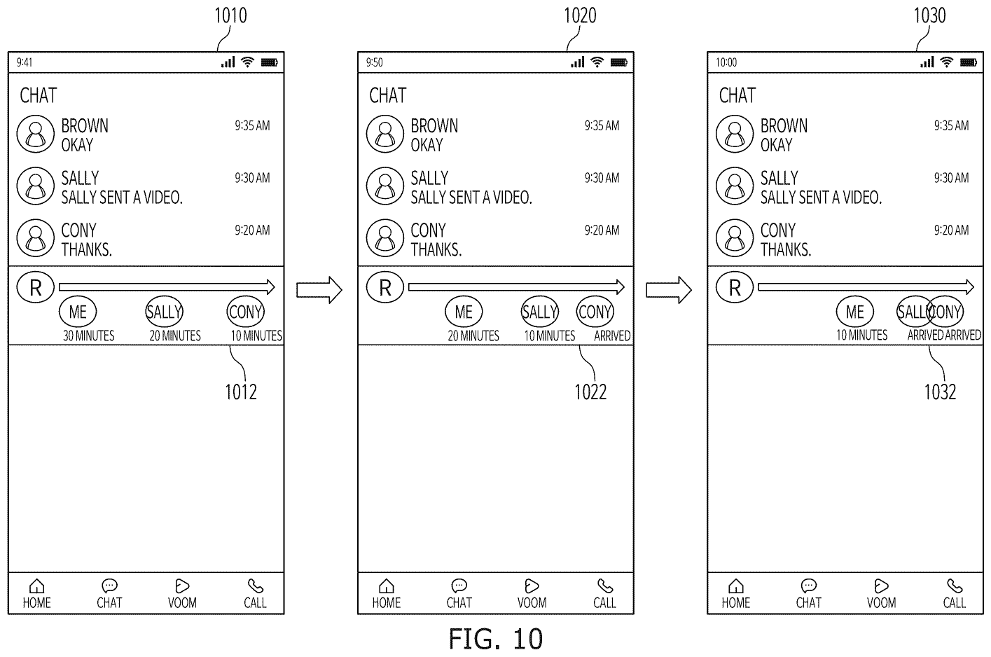

FIG. 10 is a diagram illustrating screens 1010, 1020, and 1030 of the user terminal on which graphic elements associated with fourth schedule messages 1012, 1022, and 1032 are updated over time according to one or more embodiments. The fourth schedule messages 1012, 1022, and 1032 may be messages corresponding to the fourth type (Spot Realtime). As time elapses after the fourth schedule message 1012 is displayed in the schedule notification area at the notification date and time as illustrated on the first screen 1010 of FIG. 10, the estimated time of arrival and the location of the graphic element associated with the fourth schedule messages 1022 and 1032 may be updated as illustrated on the second and third screens 1020 and 1030 of FIG. 10. In one or more embodiments, the processor may be configured to extract the user and/or participants location, time of arrival, mode of travel, speed of travel, etc., from the schedule message and/or other chat messages within the instant messaging application.

The processor included in the user terminal may extract the user's mode of transportation from the fourth schedule message and estimate the user's location. The processor may estimate the user's location based on a GNSS signal collected using a GPS module included in the user terminal. Additionally or alternatively, the processor of the user terminal may determine the travel speed of the user based on the distance traveled by the user during a predetermined time.

Additionally, the processor included in the user terminal may receive location information periodically or in real time from each mobile terminal owned by the participant (e.g., Sally, Cony). Each participant may be a participant who agreed to provide the location information, and in response to the provision of the location information, the processor of the user terminal may receive the location information from the mobile terminal owned by each participant to collect the location of each participant. Alternatively, the second external device (instant messaging service server) may receive the location information of the participant periodically or in real time.

The processor may determine a first estimated time of arrival to the destination based on the mode of transportation or the travel speed of the user, and the current location and the destination of the user. If the user's mode of transportation (e.g., walking, public transportation, or private car) is extracted from the fourth schedule message, the processor may acquire the estimated time of arrival based on the mode of transportation, the current location and the destination using a map/path finding application/service.

In addition, the processor may determine the estimated time of arrival for each participant to arrive at the destination based on the mode of transportation or the travel speed of each participant, and the current location and the destination of each participant. For example, the processor may determine a second estimated time of arrival for a first participant to arrive at the destination based on the mode of transportation or the travel speed of the first participant, the current location and the destination of the first participant. As another example, the processor may determine a third estimated time of arrival for a second participant to arrive at the destination based on the mode of transportation or the travel speed of the second participant, and the current location and the destination of the second participant. Alternatively, the second external device (instant messaging service server) may determine the estimated time of arrival for each participant and provide the determined information to the user terminal.

FIG. 10 illustrates that a long arrow is displayed in the schedule notification area as a fourth graphic element associated with the destination. In addition, a fifth graphic element associated with the user may be displayed in the schedule notification area based on the first estimated time of arrival, a sixth graphic element associated with the first participant may be displayed in the schedule notification area based on the second estimated time of arrival, and a seventh graphic element associated with the second participant may be displayed in the schedule notification area based on the third estimated time of arrival. FIG. 10 illustrates that the fifth graphic element is a user name (e.g., me), the sixth graphic element is the name of the first participant included in the address book, and the seventh graphic element is the name of the second participant included in the address book. Additionally or alternatively, the profile image of the user may be displayed in the schedule notification area as the fifth graphic element, the profile image of the first participant may be displayed in the schedule notification area as the sixth graphic element, and the profile image of the second participant may be displayed in the schedule notification area as the seventh graphic element.

The position of each of the fifth graphic element, the sixth graphic element, and the seventh graphic element displayed in the schedule notification area may be determined based on the corresponding estimated time of arrival. That is, the position of each of the fifth graphic element, the sixth graphic element, and the seventh graphic element may be displayed closer to the right end of the fourth graphic element as the corresponding estimated time of arrival is shorter.

The first to third estimated times of arrival may be recalculated in real time or at regular cycle intervals, and the positions of the displayed fifth graphic element, sixth graphic element, or seventh graphic element may be updated based on each recalculated estimated time of arrival. As illustrated on each screen 1010, 1020, and 1030 of FIG. 10, the estimated time of arrival for the user and each participant may become progressively shorter as time elapses, and accordingly, the fifth graphic element, the sixth graphic element, and the seventh graphic element may gradually approach the right end of the fourth graphic element.

The processor may determine a distance between the graphic elements displayed in the schedule notification area based on the estimated time of arrival. For example, as shown in screen 1010, R may indicate the route where the arrow indicates the beginning of the route R and the end of the route R (the destination) may be the end of the arrow. The user (i.e., ME) may be at the further distance from the destination or have the longest time of arrival to the destination, whereas SALLY may be closer to the destination or have a shorter time of arrival to the destination than ME, and CONY may be closest to the destination or have the shortest time of arrival to the designation than ME and CONY. Thus, the graphic elements associated with ME, SALLY and CONY may be displayed according to these properties, where ME is furthest from the end of the arrow, CONY is closest to the end of the arrow, and SALLY is between ME and CONY The distance between the graphic elements may be determined based on the estimated times of arrival and/or the distances from the destination, such that the location and separation of the graphic elements corresponding to ME, SALLY and CONY represent time/location separation of the user and participants from the destination as well as from each other.

If the participant or the user reaches the destination, display information (i.e., “Arrived”) indicating the arrival of the participant (i.e., Cony, Sally) may be displayed in the schedule notification area, as illustrated on the second screen 1020 and the third screen 1030 of FIG. 10. If both the user and the participant have arrived at the destination, the fourth schedule message may be removed from the schedule notification area.

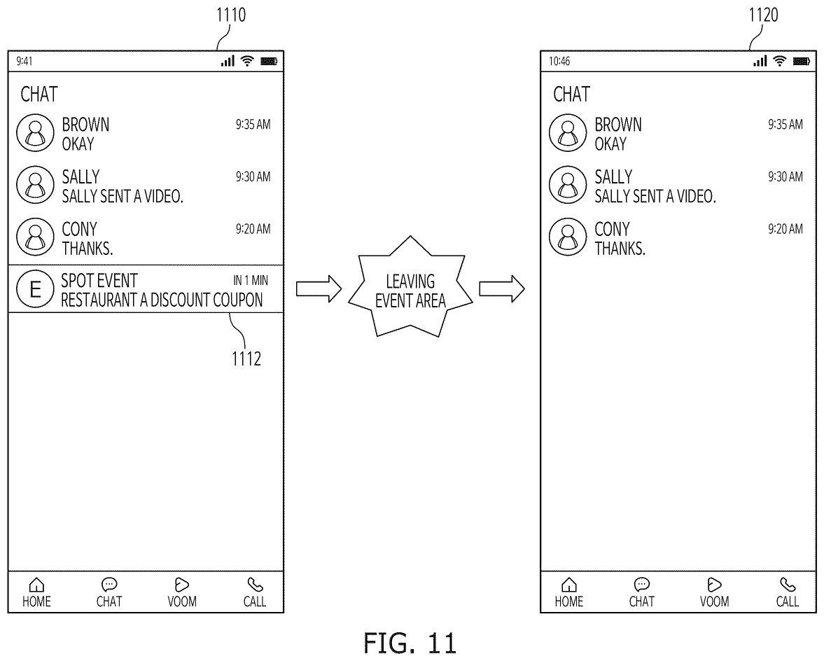

FIG. 11 is a diagram illustrating a screen 1110 of the user terminal on which an event message 1112 is displayed according to one or more embodiments. The event message 1112 may include an event area. For example, the event area may include a location range within a certain radius with respect to a specific location.

At least one processor included in the user terminal may receive the event message from the information processing system and store the event message in advance. Alternatively, in response to determining that the user terminal is within the event area, the information processing system may transmit the event message to the user terminal. The event message may be a message registered by staff at an event company. For example, the event message may include an event area, a promotional announcement, a discount coupon, an event period, etc.

The processor may extract the event area included in the event message, compare the event area with the current location of the user terminal, and determine whether the current location of the user terminal is included in the event area. In response to determining that the current location of the user terminal is included in the event area, the event message 1112 may be displayed in the schedule notification area as illustrated in the first screen 1110 illustrated in FIG. 11.

If it is determined that the user's location is out of the event area, the event message 1112 may be removed from the schedule notification area as illustrated on a second screen 1120 of FIG. 11. Additionally or alternatively, if a fourth user input that selects an event message in the schedule notification area is received, the event message 1112 may be removed from the schedule notification area after details of the event message (e.g., discount coupon image, event period, etc.) are output.

In the examples described above, it is illustrated that a chat message is output to the first area of the entire chat list area and different types of schedule messages are output to the second area, but embodiments are not limited thereto, and the schedule message may be displayed in various forms. For example, each of the schedule messages may be sorted based on the notification dates and times of the schedule messages and the reception dates and times of the chat messages, and the sorted schedule message and chat message may be output to the chat list. That is, a chat message with the earliest reception date and time or a schedule message with the earliest notification date and time may be displayed at the top or bottom of the chat list. In this case, the schedule notification area may be changed from time to time based on the reception date and time of the chat message and/or the notification date and time of the schedule message.

As another example, the schedule notification message may be fixed at the top, bottom, or middle area of the chat list. In this case, a plurality of schedule messages may be displayed together in a fixed schedule notification area.

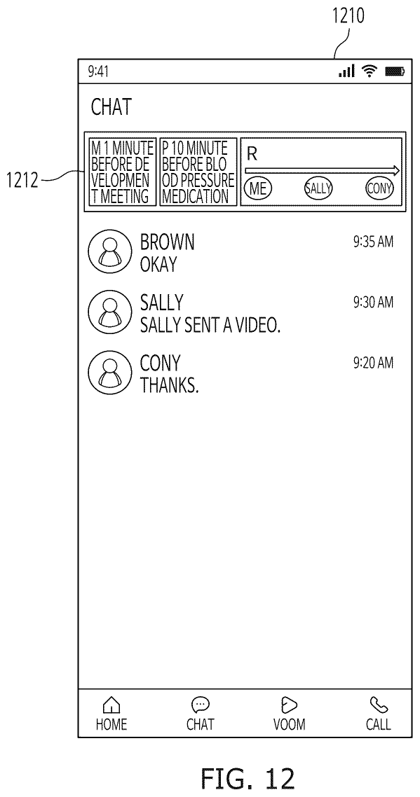

FIG. 12 is a diagram illustrating a screen 1210 of the user terminal on which the schedule message is displayed through a schedule notification area 1212 fixed at the top of the chat list according to one or more embodiments. FIG. 12 illustrates that a plurality of types of schedule messages are displayed together in the schedule notification area 1212 fixed at the top position.

Referring to FIG. 12, the first type of schedule message, the second type of schedule message, and the fourth type of schedule message may be displayed in the schedule notification area 1212 fixed at the top. In FIG. 12, it is illustrated that the fourth type of schedule message with the most distant notification date and time (that is displayed first) is displayed on the far right area, the second type of schedule message with the second order of notification date and time (that is displayed second) is displayed on the middle area, and the first type of schedule message with the most recent notification date and time (that is displayed last) is displayed at the far left area. That is, each of the schedule messages may be arranged in descending order of the notification date and time, and then the schedule messages arranged from left to right may be sequentially displayed.

Additionally or alternatively, the schedule notification area may be included in at least one of the home screen area of the instant messaging application or the screen area where the widget of the user terminal is displayed. For example, if a user input that selects a home tab of the instant messaging application is received, the home screen including the schedule notification area may be displayed. In this case, the user may check the schedule messages at a glance through the home screen. As another example, the schedule notification area may be implemented in the form of a widget, and in this case, the schedule notification area may be displayed on a widget-related screen (e.g., a background screen of the user terminal). In this case, the user may check the schedule messages through the widget-related screen.

A second user interface associated with editing the schedule message may be provided, and the user may edit the schedule included in the schedule message using the second user interface.

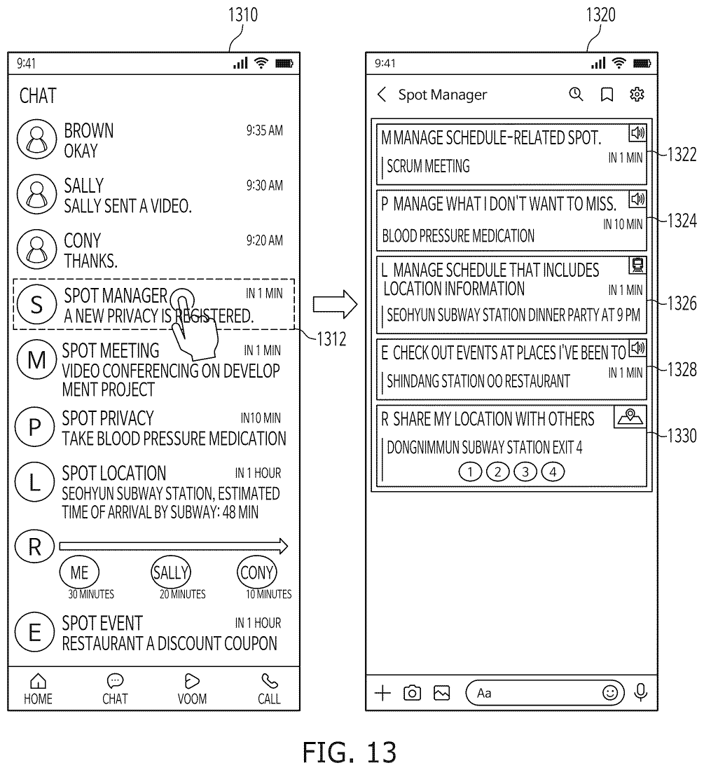

FIG. 13 illustrates an example of a second user interface 1320 associated with editing the schedule message according to one or more embodiments. As illustrated, if the schedule message or the event message is received, a management message 1312 associated with the management of the schedule message and/or the event message may be displayed in the chat list. As illustrated on a screen 1310 of FIG. 13, the management message 1312 may be displayed in the chat list together with the profile image associated with the management message.

In response to receiving a third user input that selects the management message 1312 from the chat list, the processor may output the second user interface 1320 that allows editing of at least one schedule message and event message.

At least one schedule message 1322, 1324, 1326, and 1330 and an event message 1328 displayed in the schedule notification area may be displayed on the second user interface 1320, and the schedule message or event message selected by the user may be edited. Editing the schedule message may refer to editing at least one of the schedule information, the appointment location, the meeting room, the participant, etc. The user may change a mode of transportation associated with a specific schedule message or set a basic mode of transportation by using the second user interface 1320. Editing the event message may refer to editing information related to the event, such as deleting a stored coupon, etc.

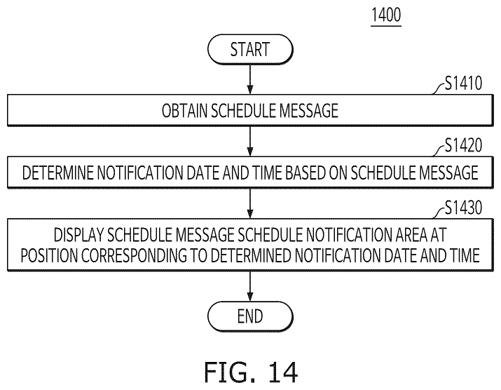

FIG. 14 is a flowchart illustrating a method 1400 for notifying a schedule using the instant messaging application according to one or more embodiments. The method illustrated in FIG. 14 is merely one example for achieving the object of the present disclosure, and it goes without saying that certain steps of operations may be added or omitted as needed. In addition, the method illustrated in FIG. 14 may be performed by at least one processor included in the user terminal illustrated in FIG. 3. For convenience of description, it will be described that each of the steps illustrated in FIG. 14 is performed by the processor included in the user terminal illustrated in FIG. 3.

The processor may obtain a schedule message generated based on the schedule information registered in the schedule application, in operation S1410. The external device may convert the schedule information registered in the schedule application into a format associated with the instant messaging application to generate a schedule message, and the processor may receive the schedule message from the external device. According to one or more embodiments, the processor may obtain the schedule information registered in the schedule application and convert the obtain schedule information into the format associated with the instant messaging application to generate a schedule message.

The processor may determine a notification date and time based on the schedule message, in operation S1420.

The processor may display the schedule message in the schedule notification area at a position corresponding to the determined notification date and time, in operation S1430. The processor may identify the schedule type included in the schedule message and display graphic information associated with the identified schedule type in the schedule notification area together with at least a part of the schedule message. A plurality of schedule messages corresponding to different schedule types may be displayed in the schedule notification area.

In addition, the processor may determine the remaining time until the schedule start date and time or the schedule end date and time included in the schedule message, and if it is determined that the determined remaining time falls within the first range, visualize the schedule message using the first graphic element. In addition, if it is determined that the determined remaining time falls within the second range, the processor may visualize the schedule message using the second graphic element.

If the destination included in the schedule message is identified, the processor may determine an estimated time of arrival to the destination based on the mode of transportation or the travel speed of the user and the current location and the destination of the user, and display the determined estimated time of arrival in the schedule notification area together with at least a part of the schedule message. The processor may determine whether the user has arrived at the destination and, in response to determining that the user has arrived at the destination, remove the schedule message from the schedule notification area.

If the destination and the participant included in the schedule message are identified, the processor may acquire the current location of the user and the current location of the participant. The processor may determine a first estimated time of arrival for the user to arrive at the destination based on the mode of transportation or the travel speed of the user and the current location and the destination of the user, and a second estimated time of arrival for the participant to arrive at the destination based on the mode of transportation or the travel speed of the participant, and the current location and the destination of the participant. In addition, the processor may display the first estimated time of arrival and the second estimated time of arrival in the schedule notification area together with at least a part of the schedule message.

Additionally, the processor may display the third graphic element associated with the destination in the schedule notification area, the fourth graphic element associated with the user based on the first estimated time of arrival in the schedule notification area, and the fifth graphic element associated with the participant in the schedule notification area based on the second estimated time of arrival. In this case, a distance between the third graphic element and the fourth graphic element may be determined based on the first estimated time of arrival. In addition, a distance between the third graphic element and the fifth graphic element may be determined based on the second estimated time of arrival.

The processor may determine whether both the user and the participant have arrived at the destination, and in response to determining that both the user and the participant have arrived at the destination, remove the schedule message from the schedule notification area.

After the schedule message is displayed in the schedule notification area, the processor may receive a first user input that selects the schedule message displayed in the schedule notification area. In this case, in response to receiving the first user input, the processor may execute an online meeting link included in the schedule message. In this case, in response to the execution of the online meeting link, the online meeting application associated with the schedule message may be executed. When executing the online meeting link included in the schedule message, the processor may determine whether there are a plurality of meetings available for participation at the current time point based on the at least one schedule message being stored. In response to determining that there are a plurality of meetings available for participation at the current time point, the processor may display a list of meetings available for participation, acquire a link to any one meeting selected by the user from the displayed meeting list, and execute the acquired link.

After displaying the schedule message in the schedule notification area, the processor may identify the schedule end date and time included in the schedule message and, in response to determining that the end date and time elapsed, remove the schedule message from the schedule notification area. Additionally or alternatively, after displaying the schedule message in the schedule notification area, if a second user input that selects the schedule message displayed in the schedule notification area is received, the processor may remove the schedule message from the schedule notification area.

The processor may acquire an event message that includes an event area. In this case, the processor may determine whether the current location of the user is included in the event area and, in response to determining that the current location of the user is included in the event area, display the event message in the schedule notification area. After the event message is displayed in the schedule notification area, the processor may determine whether the user has left the event area and, in response to determining that the user has left the event area, remove the event message from the schedule notification area.

If the schedule message is acquired, the processor may display a schedule management message associated with the management of the schedule message in the chat list of the instant messaging application. In addition, in response to receiving a third user input that selects a schedule management message, the processor may output the user interface associated with editing the schedule message.

The flowcharts and embodiments described above are merely examples, and may be implemented differently depending on embodiments. For example, in one or more embodiments, the order of respective operations may be changed, some of the operations may be repeatedly performed, some may be omitted, or some may be added.

The method described above may be provided as a computer program stored in a computer-readable recording medium for execution on a computer. The medium may be a type of medium that continuously stores a program executable by a computer, or temporarily stores the program for execution or download. In addition, the medium may be a variety of recording means or storage means having a single piece of hardware or a combination of several pieces of hardware, and is not limited to a medium that is directly connected to any computer system, and accordingly, may be present on a network in a distributed manner. An example of the medium includes a medium configured to store program instructions, including a magnetic medium such as a hard disk, a floppy disk, and a magnetic tape, an optical medium such as a CD-ROM and a DVD, a magnetic-optical medium such as a floptical disk, a ROM, a RAM, a flash memory, etc. In addition, other examples of the medium may include an app store that distributes applications, a site that supplies or distributes various software, and a recording medium or a storage medium managed by a server.

The methods, operations, or techniques of the present disclosure may be implemented by various means. For example, these techniques may be implemented in hardware, firmware, software, or a combination thereof. Those skilled in the art will further appreciate that various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software depends on design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, computer, or a combination thereof.

Accordingly, various example logic blocks, modules, and circuits described in connection with the present disclosure may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any related processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with commands stored on a computer-readable medium, such as RAM, ROM, NVRAM, PROM, EPROM, EEPROM, flash memory, CD, magnetic or optical data storage devices, etc. The commands may be executable by at least one processor, and may cause the processor(s) to perform certain aspects of the functions described in the present disclosure.

If implemented in software, the techniques described above may be stored on a computer-readable medium as one or more commands or codes, or may be transferred via a computer-readable medium. The computer-readable media include both the computer storage media and the communication media including any medium that facilitates the transmission of a computer program from one place to another. The storage media may also be any available media that may be accessible to a computer. By way of non-limiting example, such a computer-readable medium may include RAM, ROM, EEPROM, CD-ROM or other optical disk storage, magnetic disk storage or other magnetic storage devices, or any other media that may be used to transmit or store desired program code in the form of instructions or data structures and may be accessible to a computer. In addition, any connection is properly referred to as a computer-readable medium.

For example, if the software is sent from a website, server, or other remote sources using coaxial cable, fiber optic cable, twisted pair, digital subscriber line (DSL), or wireless technologies such as infrared, wireless, and microwave, the coaxial cable, the fiber optic cable, the twisted pair, the digital subscriber line, or the wireless technologies such as infrared, wireless, and microwave are included within the definition of the medium. The disks and the discs used herein include CDs, laser disks, optical disks, DVDs, floppy disks, and Blu-ray disks, where disks usually magnetically reproduce data, while discs optically reproduce data using a laser. The combinations described above should also be included within the scope of the computer-readable media.

The software module may reside in RAM memory, flash memory, ROM memory, EPROM memory, EEPROM memory, registers, hard disk, removable disk, CD-ROM, or any other form of storage medium known. An example storage medium may be connected to the processor, such that the processor may read or write information from or to the storage medium. Alternatively, the storage medium may be integrated into the processor. The processor and the storage medium may be present in the ASIC. The ASIC may be present in the user terminal. Alternatively, the processor and storage medium may exist as separate components in the user terminal.

Although the examples described above have been described as utilizing aspects of the currently disclosed subject matter in one or more standalone computer systems, aspects are not limited thereto, and may be implemented in conjunction with any computing environment, such as a network or distributed computing environment. Furthermore, the aspects of the subject matter in the present disclosure may be implemented in multiple processing chips or devices, and storage may be similarly influenced across a plurality of devices. Such devices may include PCs, network servers, and portable apparatus.

According to one or more embodiments of the present disclosure, if the schedule information is registered in the schedule application, a schedule message may be automatically generated based on the registered schedule information, and the schedule message may be displayed in the schedule notification area at the notification date and time through the instant messaging application. As a result, the hassle of the user who has to enter a chat room and register a schedule separately may be eliminated, and user inputs required to register the schedule message may be minimized. In addition, because instant message-based schedule messages are automatically generated in conjunction with user-friendly schedule applications without requiring entry to a chat room to register the schedule message, user convenience may be improved when registering schedule messages. The schedule messages may also be easily checked in the schedule notification area without having to enter the chat room of the instant messaging application.

According to one or more embodiments of the present disclosure, the schedule message may be displayed together with graphic information based on a type of the schedule message. As a result, the user may intuitively identify the type of the schedule message, and quickly check various information through various types of schedule messages.

According to one or more embodiments of the present disclosure, if the user input that selects the schedule message is received, the online meeting application associated with the link included in the schedule message may be automatically executed. As a result, the hassle of the user who has to enter the chat room or separately execute the online meeting application to proceed with the schedule may be eliminated.

According to one or more embodiments of the present disclosure, if the destination is included in the schedule message, the estimated time of arrival for the user or the participant to the destination may be displayed together with at least a part of the schedule message. As a result, the user may intuitively estimate the arrival time of the participant or the user himself/herself.

According to one or more embodiments of the present disclosure, various graphic elements may be displayed together with at least a part of the schedule message based on the remaining time until the schedule start date and time or the end date and time. Accordingly, the user may intuitively check the remaining time until the schedule start date and time or the end date and time.

Each of the embodiments provided in the above description is not excluded from being associated with one or more features of another example or another embodiment also provided herein or not provided herein but consistent with the disclosure.

While the disclosure has been particularly shown and described with reference to embodiments thereof, it will be understood that various changes in form and details may be made therein without departing from the spirit and scope of the following claims.

What is claimed is:

1. A method for providing a schedule notification using an instant messaging application, the method being performed by one or more processors of a user terminal and comprising:
obtaining a schedule message generated based on schedule information registered in a schedule application;
determining a notification date and time based on the schedule message; and
displaying the schedule message in a schedule notification area of the user terminal at a position in the instant message application corresponding to the determined notification date and time.

2. The method according to claim 1, wherein the obtaining the schedule message comprises receiving the schedule message from an external device, the schedule message being generated by the external device by converting the schedule information registered in the schedule application into a format associated with the instant messaging application.

3. The method according to claim 1, wherein the obtaining the schedule message comprises:
obtaining the schedule information registered in the schedule application; and
generating the schedule message by converting the obtained schedule information into a format associated with the instant messaging application.

4. The method according to claim 1, wherein the displaying the schedule message in the schedule notification area comprises:
identifying a schedule type included in the schedule message; and
displaying, in the schedule notification area, graphic information associated with the identified schedule type together with at least a portion of the schedule message.

5. The method according to claim 1, further comprising after displaying the schedule message in the schedule notification area:
receiving a first user input that selects the schedule message displayed in the schedule notification area;
based on receiving the first user input, executing an online meeting link included in the schedule message; and
based on execution of the online meeting link, executing an online meeting application associated with the schedule message.

6. The method according to claim 5, wherein the executing the online meeting link included in the schedule message comprises:
determining whether a plurality of meetings are available for participation at a current time, based on at least one stored schedule message;
based on determining that the plurality of meetings are available for participation at the current time, displaying a list of meetings available for participation;
obtaining a link to a meeting selected by a user from the displayed list of meetings; and
executing the obtained link.

7. The method according to claim 1, further comprising, after displaying the schedule message in the schedule notification area:
identifying a schedule end date and end time included in the schedule message; and
based on determining that the schedule end date and end time has elapsed, removing the schedule message from the schedule notification area.

8. The method according to claim 1, further comprising, after displaying the schedule message in the schedule notification area:
receiving a second user input that selects the schedule message displayed in the schedule notification area; and
based on receiving the second user input, removing the schedule message from the schedule notification area.

9. The method according to claim 1, wherein the displaying the schedule message in the schedule notification area comprises:
determining a remaining time until a schedule start date and start time or a schedule end date and end time included in the schedule message;
based on determining that the remaining time is within a first range, visualizing the schedule message using a first graphic element; and
based on determining that the remaining time is within a second range, visualizing the schedule message using a second graphic element.

10. The method according to claim 1, wherein the displaying the schedule message in the schedule notification area comprises:
identifying a destination included in the schedule message;
determining an estimated time of arrival to the destination based on a mode of transportation and/or a travel speed of a user, a current location of the user, and the destination; and
displaying, in the schedule notification area, the determined estimated time of arrival together with at least a portion of the schedule message.

11. The method according to claim 10, further comprising, after displaying the schedule message in the schedule notification area:
determining whether the user has arrived at the destination; and
based on determining that the user has arrived at the destination, removing the schedule message from the schedule notification area.

12. The method according to claim 1, wherein the displaying the schedule message in the schedule notification area comprises:
identifying a destination and a participant included in the schedule message;
obtaining a current location of a user and a current location of the participant;
determining a first estimated time of arrival for the user to arrive at the destination based on a mode of transportation and/or a travel speed of the user, the current location of the user, and the destination;
determining a second estimated time of arrival for the participant to arrive at the destination based on a mode of transportation and/or a travel speed of the participant, the current location of the participant, and the destination; and
displaying, in the schedule notification area, the first estimated time of arrival and the second estimated time of arrival together with at least a portion of the schedule message.

13. The method according to claim 12, wherein the displaying the schedule message in the schedule notification area further comprises:
displaying a third graphic element associated with the destination in the schedule notification area;
displaying a fourth graphic element associated with the user in the schedule notification area based on the first estimated time of arrival; and
displaying a fifth graphic element associated with the participant in the schedule notification area based on the second estimated time of arrival, and
wherein the method further comprises:
determining a distance between the third graphic element and the fourth graphic element based on the first estimated time of arrival, and
determining a distance between the third graphic element and the fifth graphic element based on the second estimated time of arrival.

14. The method according to claim 12, further comprising, after displaying the schedule message in the schedule notification area:
determining whether both the user and the participant have arrived at the destination; and
based on determining that both the user and the participant have arrived at the destination, removing the schedule message from the schedule notification area.

15. The method according to claim 1, further comprising:
obtaining an event message that comprises an event area;
determining whether a current location of a user is included in the event area; and
based on determining that the current location of the user is included in the event area, displaying the event message in the schedule notification area.

16. The method according to claim 15, further comprising, after displaying the event message in the schedule notification area:
determining whether the user has left the event area; and
based on determining that the user has left the event area, removing the event message from the schedule notification area.

17. The method according to claim 1, wherein the schedule notification area is included in at least one of a screen area where a chat list of the instant messaging application is displayed, a home screen area of the instant messaging application, and a screen area where a widget of the user terminal is displayed.

18. The method according to claim 1, further comprising:
based on the schedule message being obtained, displaying a schedule management message associated with a management of the schedule message in a chat list of the instant messaging application; and
based on receiving a third user input that selects the schedule management message, outputting a user interface associated with editing the schedule message.

19. A non-transitory computer-readable recording medium storing instructions that, when executed by one or more processors, cause a user terminal to:
obtain a schedule message generated based on schedule information registered in a schedule application;
determine a notification date and time based on the schedule message; and
display the schedule message in a schedule notification area of the user terminal at a position in an instant message application corresponding to the determined notification date and time.

20. A user terminal, comprising:
a display;
memory storing instructions; and
one or more processors,
wherein the instructions, when executed by the one or more processors, cause the user terminal to:
obtain a schedule message generated based on schedule information registered in a schedule application;
determine a notification date and time based on the schedule message; and
display, on the display, the schedule message in a schedule notification area at a position in an instant message application corresponding to the determined notification date and time.
